(19) United States
(12) Patent Application Publication
(10) Pub. No.: US 2009/0241984 A1
(43) Pub. Date: Oct. 1, 2009

(54) Flossing Dental Tool for Use with Fixed Orthodontic Appliance

(76) Inventor: William J. Wall, Winchester, TN (US)

Correspondence Address: BRIAN D. SMITH, P.C., 1125 SEVENTEENTH STREET, SUITE 600, DENVER, CO, 80202, US

(21) Appl. No.: 12/409,712

(22) Filed: Mar. 24, 2009

Related U.S. Application Data
(60) Provisional application No. 61/039,843, filed on Mar. 27, 2008.

(51) Int. Cl. A61C 15/04

(52) U.S. Cl. 132/323

(57) ABSTRACT

A dental tool for flossing the teeth of a person having braces includes a handle having a rotatably mounted head. The head has spaced first and second prongs which are thin enough to extend between the wire of the braces and the juncture of two teeth. The first and second prongs are provided with slots at their ends for receiving a strand of dental floss. Cleats attached to the prongs are also provided for securing the strand tautly between the prongs and through the slots.

### CROSS REFERENCE TO RELATED APPLICATION

This application is a nonprovisional application claiming the benefit under 35 USC 119(e) of U.S. provisional application no. 61/039,843, filed on Mar. 27, 2008.

### TECHNICAL FIELD

This invention relates to a dental flossing tool, and more particularly to a dental flossing tool especially designed for use with fixed orthodontic appliances.

### BACKGROUND ART

Various approaches to flossing teeth have long been used, both by individuals and by dental professionals. The most basic approach to flossing is the well known method of flossing by hand, typically using floss dispensed from a spool and wrapped around the fingers. This is a workable approach, but can be slow, and it lacks leverage because the hands necessarily grip the floss immediately next to the location to be flossed. Flossing by hand also makes some spots deeper in the mouth difficult to access and view, since the hands themselves tend to get in the way.

Disposable flossing tools such as the one shown in U.S. Design Pat. No. D532,934 to Crossman are commonly used alternatives to flossing by hand. Such devices provide speed and leverage not found with flossing by hand, and also tend to give a more unobstructed view and easier access to more difficult-to-reach spots in the mouth. However, in such devices the floss is fixed in an in-line position relative to the handle. This fixed in-line position of the floss is convenient for flossing teeth near the front of the mouth, where flossing is ideally performed with the floss at an angle aimed approximately directly into the mouth. However, this fixed in-line orientation of the floss makes flossing of back teeth more difficult, since the back teeth must necessarily be flossed with the floss at a more transverse angle relative to the mouth. In addition, disposable flossing tools are generally wasteful, as they are by definition designed to be discarded after use. Further, disposable flossing tools typically have relatively short handles, which provide little leverage and may result in the gripping hand getting in the way of both the user's work and his view.

U.S. Patent Pub. No. US 2006/0169299A1 to Jansheski et al provides a handle system for use with a disposable flossing tool. While the Jansheski device solves the problems related to the short handle of the typical disposable flossing tool, there still remain the problems of waste and of difficulty in accessing rear teeth at an efficient angle.

In order to allow better angles of approach to rear teeth, several flossing tools have been used which have rotating heads. These rotating heads allow the floss to be selectively oriented at the angle most advantageous to the location of the teeth to be flossed. Examples of rotating heads may be found in U.S. Patent Pub. No. US 2007/0044815 to Ashraf; and in U.S. Pat. Nos. 4,920,992; 5,010,906; and 5,127,415, to Preciutti. All of the Ashraf and Preciutti devices provide flossing heads which may be oriented at selected angles relative to the handle of the device, in order to allow ease of flossing regardless of the location of the teeth to be flossed. However, in each of the foregoing devices the floss is bonded to the head portion. This is inherently wasteful, since at a minimum both the floss and head must be discarded after each use. This approach also restricts the user's choice to the particular floss/head combination utilized by the respective device.

In an attempt to address the problem of waste, some devices have utilized a spool of floss built into the device itself. U.S. Pat. No. 6,092,536 to Owens provides a flossing tool having such a built-in spool. While this arrangement might arguably be less wasteful of some materials than devices using disposable heads with pre-installed floss, the Owens device actually uses considerably more floss than a device with a disposable head. In fact, the device uses a relatively large amount of floss, because it runs floss from the spool down the handle, then down one leg and across to the other leg, before finally tying off the excess. In addition, the head of the Owens device is not rotatable, causing the same problems discussed earlier due to the fixed position of the floss. It would actually not be workable for the Owens device to incorporate a rotating head, since to do so would cause problems with the tension in the floss. This may be readily seen by referring to FIGS. 1 and 2 of the Owens Patent, as described at Col. 4, lines 37-41. It is evident upon inspection, that tension in the floss of the Owens tool is maintained in a loop beginning at the spool 58 and ending at cleat 68, where the floss is tied off. If the head of the Owens device were to rotate, it could not effectively rotate in the direction which would pull the floss tighter, as the floss must necessarily already be near its maximum tension at the outset in order to provide the tautness required for flossing operations. On the other hand, if the head were to rotate in the opposite direction, this would cause slack in the floss, rendering it incapable of a proper flossing operation. Finally, users of the Owen tool are also limited to a spool of floss which will be readily accommodated by the spool compartment provided.

U.S. Pat. No. 6,997,191 to Nudo provides a flossing tool having a built-in spool of floss and a rotating head or “bridge” 33, which is rotatably mounted on stem 39. The bridge comprises two support posts 34,35 around which floss may be wrapped. In operation (see Col. 3, lines 43-54), floss is first pulled from the spool through channel 32 where it is secured, then placed around the posts, and extra line is removed by cutter 24 located at the opposite end of the device from the head. The loose end of the line is then secured by wrapping it around the stem. The line of floss remains attached to the spool until after the flossing is complete (Col. 3, lines 52-53). Based on the foregoing description of Nudo's operation, the rotating head of his device would suffer from the same problems discussed above with respect to the Owens device. That is, the floss must begin any operation in a taut position; therefore, any rotation of the head in a tightening direction would necessarily be severely limited. On the other hand, any rotation in a direction opposite the tightening direction would cause unacceptable slack in the floss, rendering it incapable of performing its intended flossing operation. In addition, a considerable amount of excess floss would remain after cutting the loose end of the floss at the opposite end of the device from the head. Wrapping that much excess floss around the stem to tie it off would thus tend to impair rotation of the head on the stem, which is also an undesirable result.

U.S. Pat. No. 6,006,762 to Hsia provides a flossing tool having a built-in spool, while also providing a flossing head capable of effective rotation. Hsia's tool makes rotation possible by cutting the floss prior to mounting it to the head, using a cutter built into the head itself. By attaching a free strand of floss to the head, Hsia circumvents the binding/slack problems discussed above with respect to devices which leave the floss attached to the spool. However, Hsia provides for affixing the floss to the head in a wasteful and time-consuming manner. As described in his Patent (Col. 5, lines 58-67; Col. 6, lines 1-17), Hsia utilizes a procedure requiring at least nine steps to affix the floss to the head. This procedure is clearly time-consuming and inconvenient to users of the device. Furthermore, according to Hsia himself, the majority of the dental floss is wrapped around the base of the flossing head (Col. 5, lines 61-63). This is in addition to portions of the floss which pass across Hsia's locks, keys, and keyholes, and through other various locations enumerated by Hsia. It is thus readily apparent that a great deal of floss is consumed in Hsia's complex loading procedure.

In addition to the foregoing general problems in the field of flossing, there are special problems associated with flossing teeth to which a fixed orthodontic appliance (commonly called “braces”) has been attached. Typically, such orthodontic appliances include brackets affixed to the individual teeth, with arch wires under tension connecting the brackets. Therefore, in order to floss teeth to which such an appliance has been attached, it is necessary to find a way to circumvent the arch wire, which by its close proximity to the teeth prevents conventional flossing. None of the foregoing known devices are capable of flossing in a situation in which an orthodontic appliance is present, primarily because they are too bulky for the task.

The simplest way of flossing teeth to which an orthodontic appliance is attached is by first threading the floss through the juncture between two teeth below the arch wire using a standard floss threader (simply a thin strand of semi-rigid material having a loop at one end for receiving the floss). Once the floss has been threaded through the selected juncture using the floss threader, the threader is removed and the teeth are flossed manually. This approach is functional, but the required threading slows the process considerably, and the flossing itself is slowed due to the awkward maneuvering around the arch wire. Due to the slowness and awkwardness of the manual flossing process, wearers of orthodontic appliances—the vast majority of whom are children—are discouraged from regular flossing.

U.S. Pat. No. 5,101,843 to Peng provides a disposable flossing tool particularly designed for use with an orthodontic appliance. To accomplish this objective, Peng's device has two floss supports which are thin enough (less than 1 mm in diameter, according to Peng) to fit in the very narrow gap between the teeth and the arch wire of the appliance. However, Peng's device suffers from some of the same drawbacks discussed above with respect to other disposable flossing tools. For example, one problem with Peng's device is that it provides no extended handle, and thus must be gripped with the fingers quite near to the floss itself. Therefore, Peng's tool lacks leverage and maneuverability, while the view of the mouth also tends to be obscured by the hand. In addition, the floss of Peng's device is fixed at an in-line angle, thus making it more difficult to access teeth nearer the back of the mouth. Still further, the Peng tool is disposable and therefore wasteful.

There is thus a need for a flossing tool capable of flossing teeth bearing a fixed orthodontic appliance, and which does not suffer from the foregoing drawbacks. Such a tool would be easily maneuverable into any area of the mouth, while doing so without the user's hand obscuring his view. Further, the angle of the floss would be adjustable so that the floss could be inserted at the optimum angle for the selected teeth being flossed. In addition, the tool would be convenient to use, and in particular would require a minimum of setup time to prepare for use. The tool would also allow the user to make his own choice as to the type of floss to be used in flossing. Finally, the tool would not be wasteful of floss or other material, so as to be cost-efficient and environmentally friendly.

### SUMMARY OF THE INVENTION

The present invention provides a dental tool for flossing the teeth of a person having braces attached to his or her teeth. The braces would typically be a fixed orthodontic appliance of the type including brackets attached to the teeth and a wire under tension connecting the brackets.

The dental or flossing tool includes a handle, preferably an elongated handle, for holding the tool. In addition, the tool is provided with a flossing head which is rotatably mounted to the handle. The head has spaced first and second prongs, each of which is thin enough to extend between the wire of the braces and the juncture of two teeth. The first and second prongs are preferably provided with slots for receiving a strand of dental floss. First and second floss securing means are also provided for respectively securing the first and second ends of a free strand of dental floss so that the strand may be tautly secured between the prongs and through the slots to enable the strand to be extended through the juncture for flossing thereof. The first and second securing means also secure the strand to the prongs without hindering rotation of the flossing head.

In a preferred embodiment, the first floss securing means includes a first cleat attached to the first prong to which an end of a strand of floss may be tied. Similarly, the second floss securing means includes a second cleat attached to the second prong to which the other end of the strand of floss may be tied so that the strand may be tautly secured between the prongs and through the slots. Cleats are preferred because they are easy to use and enable the ends of the strand to be tied off very quickly.

In view of the foregoing, several advantages of the present invention are readily apparent. A flossing tool is provided which is capable of flossing teeth bearing a fixed orthodontic appliance. The tool is easily maneuverable into any area of the mouth, and may be so maneuvered without the user's hand obscuring the view of the flossing operation or interfering with the flossing itself. In addition, the angle of the floss may be adjusted by rotating the head of the tool, so that the floss may be inserted at the optimum angle for the selected teeth being flossed. Further, the tool is convenient to use, and in particular requires a minimum of setup time to prepare for use. The tool also allows the user to make his own choice as to the type of floss to be used in flossing. Finally, the tool is not wasteful of floss or other material, and is therefore cost-efficient and environmentally friendly.

Additional advantages of this invention will become apparent from the description which follows, taken in conjunction with the accompanying drawings.

### BRIEF DESCRIPTION OF THE DRAWINGS

The invention will be more readily understood by reference to the accompanying drawings wherein like reference numerals indicate like elements, and wherein reference numerals sharing the same last two digits identify similar corresponding elements throughout the various disclosed embodiments, and in which:

FIG. 1 is a side view of the flossing tool of the present invention;

FIG. 2 is a perspective view of the head of the flossing tool, showing floss loaded and ready for use;

FIG. 3 is a bottom view of the head of the flossing tool, illustrating rotation of head;

FIG. 4 is a perspective view of the flossing tool in use in the mouth of a wearer of a fixed orthodontic appliance; and

FIG. 5 is a top view of the flossing tool in use, depicting rotation of the head for flossing of rear teeth.

### DETAILED DESCRIPTION OF THE INVENTION

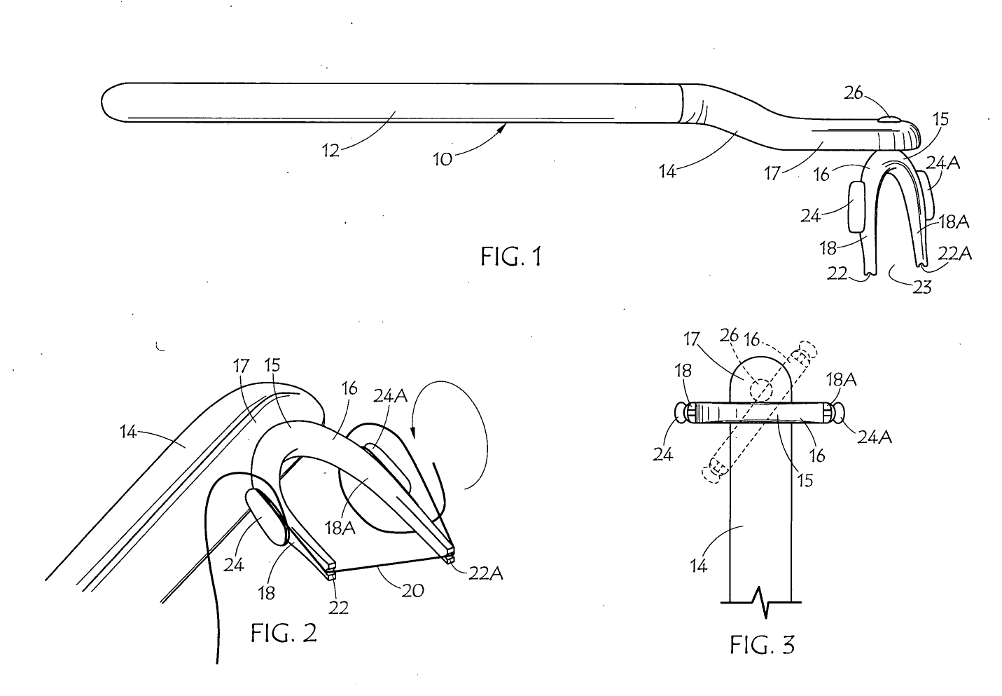

Referring now to the drawings, as shown in FIGS. 1-3 there is depicted a flossing dental tool 10 according to the present invention. The tool 10 includes an elongated handle 12 and a shank 14, with a flossing head 15 mounted to the distal end 17 of the shank. The flossing head 15 includes a U-shaped fork 16, which has two floss support prongs or legs 18,18A adapted to receive a strand of floss 20, and two cleats 24,24A to secure both ends of the strand 20.

To prepare the tool 10 for use, a strand of floss 20 of suitable length is first obtained. One end of the strand 20 is then secured in place by wrapping it around the first cleat 24. The strand 20 is then extended along support leg 18 and passed through guide notch 22 at the end of the leg 18. The floss 20 is then passed across the gap 23 between the prongs 18,18A, and through a second guide notch 22A at the end of prong 18A. From there the floss 20 is stretched taut and wrapped around the second cleat 24A, thus locking the strand 20 in place. With the floss 20 now stretched taut across the gap 23 and secured between the cleats 24,24A, the flossing tool 10 is ready for use.

A further useful feature of the flossing tool 10 is that the head 15 is rotatably mounted to the shank 14. The fork 16 is attached to swivel 26, which is itself rotatably mounted within the shank 14. In this way, the entire head 15 is made rotatable through a full 360 degrees.

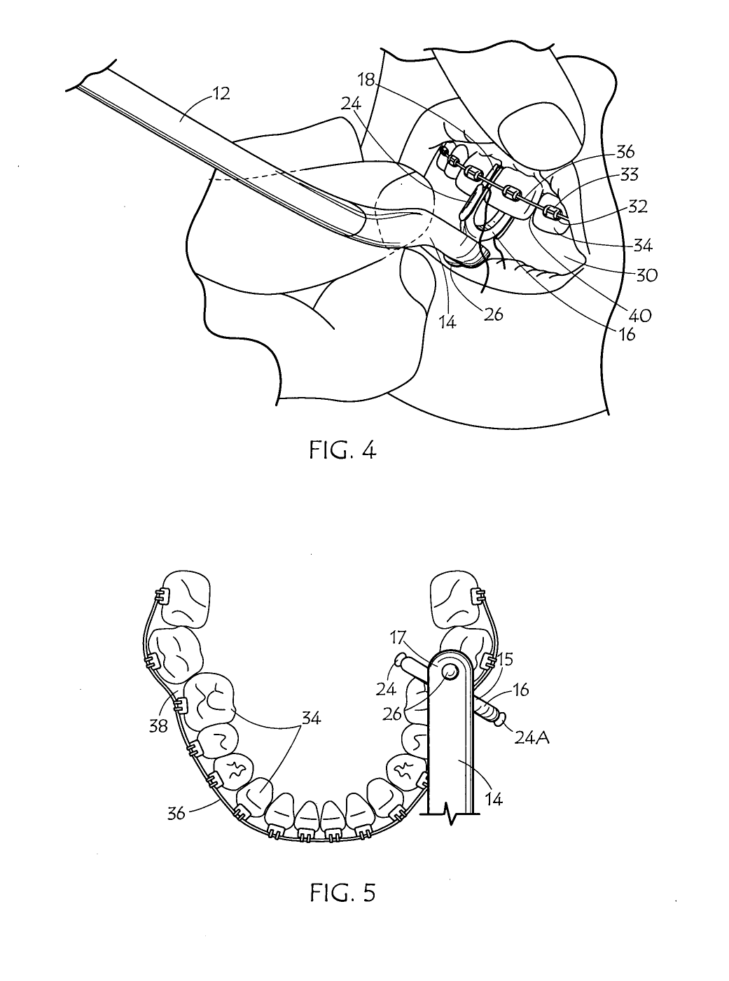

Referring now to FIGS. 4 and 5, the use of the tool 10 for flossing in the mouth 30 of a patient having a fixed orthodontic appliance 32 is depicted. The orthodontic appliance 32 is affixed to the teeth 34 of the patient by brackets 33 attached thereto. As is typical of such orthodontic appliances, the brackets 33 are connected to each other by an arch wire 36 under tension. As best seen in FIG. 5, the necessary proximity of the arch wire 36 to the teeth 34 leaves only a very small clearance 38 between the wire and the teeth. However, as shown in FIGS. 4 and 5, the floss support prongs 18,18A of the flossing tool 10 are purposely designed to be sufficiently thin so as to fit between the arch wire 36 and the teeth 34. By thus passing one of the floss support prongs 18,18A into the narrow clearance 38 between the arch wire 36 and the teeth 34, the floss 20 may be easily positioned so as to allow flossing of the juncture 40 between the selected individual teeth 34.

As may be seen in FIGS. 4 and 5, the ideal angle of the floss for flossing the front teeth is with the floss approximately aligned in the same line as the handle (the “in-line” position). However, as the flossing operation moves progressively from the front teeth further backward into the mouth, the ideal angle of the floss also changes slightly with each successive set of teeth, until near the back of the mouth the ideal angle of the floss is approximately at right angles to what it was for flossing the front teeth. As best seen in FIG. 5, the rotating head 15 allows this ideal angle of the floss to be easily selected merely by rotating the head 15 as needed.

This invention has been described in detail with reference to a particular embodiment thereof, but it will be understood that various other modifications can be effected within the spirit and scope of this invention. For example, while prongs are provided with cleats for tying off the floss other means for securing or tying off the floss to the prongs or head are considered to be within the scope of the present invention. Such means could include clips, holes through the prongs, notches on posts about which the floss could be wrapped or any other means for securing the floss to the prongs or rotatable head of the device which allows the floss to be quickly tied off and yet still permit unhindered rotation of the head after the floss is tied off.

I claim:

1. A dental tool for flossing the teeth of a person having a fixed orthodontic appliance attached to his or her teeth, said appliance including brackets attached to the teeth and a wire under tension connecting the brackets, said flossing tool comprising:
a handle for holding said flossing tool;
a flossing head rotatably mounted to said handle and having a first and a second prong, each of said prongs being thin enough to extend between said wire and the juncture of two teeth;
a first slot located at the end of said first prong and a second slot located at the end of said second prong, for receiving a strand of dental floss;
first and second floss securing means for respectively securing the first and second ends of a free strand of dental floss so that the strand may be tautly secured between said prongs and through said slots to enable the strand to be extended through said juncture for flossing thereof, said first and second securing means also securing the strand without hindering rotation of said flossing head.

2. The dental tool as claimed in claim 1 wherein at least one of said first and second floss securing means includes a cleat attached to one of said prongs to which an end of a strand of floss may be tied.

3. The dental tool as claimed in claim 1 wherein said first floss securing means includes a first cleat attached to said first prong to which an end of a strand of floss may be tied and wherein said second floss securing means includes a second cleat attached to said second prong to which the other end of the strand of floss may be tied so that the strand may be tautly secured between said prongs and through said slots to enable the strand to be extended through said juncture for flossing thereof.

4. The dental tool as claimed in claim 1 wherein said handle is elongated.

5. A dental tool for flossing the teeth of a person having a fixed orthodontic appliance attached to his or her teeth, said appliance including brackets attached to the teeth and a wire under tension connecting the brackets, said flossing tool comprising:
an elongated handle for holding said flossing tool;
a flossing head rotatably mounted to said handle and having a first and a second prong, each of said prongs being thin enough to extend between said wire and the juncture of two teeth;
a first slot located near the end of said first prong and a second slot located near the end of said second prong, for receiving a strand of dental floss;
a first cleat located on said first prong; and
a second cleat located on said second prong, such that a free strand of dental floss may be secured to said first cleat, passed tautly between said prongs and through said slots, and secured to said second cleat so that the strand of floss may be extended through said juncture for flossing thereof.

6. A method for flossing the teeth of a person having a fixed orthodontic appliance attached to his or her teeth, the appliance including brackets attached to the teeth and a wire under tension connecting the brackets, said method including the steps of:
providing a free strand of dental floss having a first and second end;
providing a dental tool for flossing including:
a handle for holding the flossing tool;
a flossing head rotatably mounted to the handle and having a first and a second prong, each of which is thin enough to extend between the wire and the juncture of two teeth;
a first slot located at the end of the first prong and a second slot located at the end of the second prong, for receiving the strand of floss;
first and second floss securing means for respectively securing the first and second ends of the free strand of floss so that the strand may be tautly secured between the prongs and through the slots to enable the strand to be extended through the juncture for flossing thereof, the first and second securing means also securing the strand without hindering rotation of the flossing head;
securing the first end of the strand of floss to the first securing means;
passing the strand tautly between the prongs and through the slots, and securing the second end of the strand to the second securing means so that the strand of floss may be extended through the juncture for flossing thereof.

7. A method for flossing as claimed in claim 6 further comprising rotating the flossing head as desired to facilitate flossing.
